(19) United States
(12) Patent Application Publication
(10) Pub. No.: US 2021/0254655 A1
(43) Pub. Date: Aug. 19, 2021

(54) CLIP FOR RELEASABLY CONNECTING COMPONENTS

(71) Applicant: Mario Brosche, Mering (DE)

(72) Inventor: Mario Brosche, Mering (DE)

(21) Appl. No.: 17/174,636

(22) Filed: Feb. 12, 2021

(30) Foreign Application Priority Data
Feb. 14, 2020 (DE) 102020201853.7

(51) Int. Cl. F16B 45/06; F16B 17/00; F16B 5/00; F16B 5/06

(52) U.S. Cl. CPC F16B 45/06; F16B 17/008; F16B 2005/0678; F16B 5/0614; F16B 2200/40; F16B 5/0012

(57) ABSTRACT

A clip for releasably connecting a first component, in particular a first plate element, to a second component, in particular a second plate element, wherein the first component comprises at least one projecting edge portion, wherein the edge portion comprises a respective recess at its opposite end regions, and the second component comprises at least one elongated hole, wherein the edge portion penetrates the elongated hole in an assembled state and projects out of the elongated hole at least so far that the recesses project at least partly out of the elongated hole. The clip comprises: two longitudinal elements each having a first and a second end, wherein the two longitudinal elements are movably connected to each other at the respective first end; a closure element provided at the second end of at least one longitudinal element, wherein the closure element is configured to releasably connect the second ends of the longitudinal elements; and at least two holding segments which are provided in opposite end regions of the longitudinal elements and which are configured to be engaged with the respective recesses of the edge portion of the first component and releasably connect the components to each other.

### CROSS-REFERENCE TO RELATED APPLICATIONS

This application claims priority under 35 U.S.C. § 119 to German Patent Application No. DE 10 2020 201 853.7, filed Feb. 14, 2020, the entire disclosure of which is hereby incorporated by reference in its entirety.

### BACKGROUND

The present invention relates to a clip for releasably connecting components, in particular for releasably connecting components of, e.g., a furniture system, an organization or storage system, a point-of-scale display, a furniture system or housing for pets, a picture frame or a transport packaging.

Assembly sets for, e.g., furniture systems using elastic rubber bands or rubber rings for releasably connecting the various elements are known in the art.

For example, DE 20 2014 103 445 U1 relates to a storage rack element and a cover plate element intended to be used in a modular storage rack which comprises at least one storage rack element of this kind. In this connection, the various plate elements are connected to each other by using O-rings (rubber rings). The plate elements comprise projecting edge portions having a recess at opposite end regions. The edge portions of a first plate element are inserted through elongated holes of a second plate element and subsequently fixed by an O-ring engaging in the recesses.

Moreover, DE 20 2014 103 446 U1 relates to a standing piece of furniture in which an object is received and stored and from which an object is removed, wherein also in this case the various plate elements are connected to each other by means of O-rings (rubber rings).

### SUMMARY OF THE DISCLOSURE

It is an object of the present invention to provide devices, systems and methods allowing a stable, simple and long-lasting releasable connection of components. This object is achieved with the features of the independent claims. The dependent claims relate to further aspects of the invention.

According to an aspect of the present invention, there is provided a clip for releasably connecting a first component, in particular a first plate element, to a second component, in particular a second plate element. The first component comprises at least one projecting edge portion, wherein the edge portion comprises a respective recess at its opposite end regions, and the second component comprises at least one elongated hole, wherein the edge portion penetrates the elongated hole in an assembled state and projects out of the elongated hole at least so far that the recesses project at least partly out of the elongated hole. The clip comprises: two longitudinal elements each having a first and a second end, wherein the two longitudinal elements are movably connected to each other at the respective first end; a closure element provided at the second end of at least one longitudinal element, wherein the closure element is configured to releasably connect the second ends of the longitudinal elements; and at least two holding segments which are provided in opposite end regions of the longitudinal elements and which are configured to be engaged with the respective recesses of the edge portion of the first component and releasably connect the components to each other.

The above-mentioned ends (first and second ends) of the longitudinal elements are formed in the longitudinal direction of the longitudinal elements.

The above-mentioned end regions of the longitudinal elements are also formed in the longitudinal direction of the longitudinal elements.

The longitudinal elements can have a horizontal bulge (curvature) in the longitudinal direction. The bulge is preferably 0.6 mm.

This allows production tolerances, especially in the area of the edge portion and particularly in the area of the recesses, to be bridged.

Moreover, the lifetime of the components, especially in the area of the edge portion and particularly in the area of the recesses, can be increased, in particular in that the bulge “cushions” impacts and thus protects the recesses from wear.

The at least two holding segments are preferably engaged with the recesses of the edge portion of the first component when the edge portion penetrates the elongated hole.

The at least two holding segments can have a maximum first height and the first and/or the second longitudinal element can have a minimum second height, wherein the first height is lower than the second height.

The heights of the at least two holding segments and of the longitudinal elements can mean an extension of the elements perpendicular to the direction from the first to the second end of the longitudinal elements and perpendicular to a direction from the first end of the first longitudinal element to the first end of the second longitudinal element connected thereto.

In other words, the direction of the respective heights can be perpendicular to the plane in which the two longitudinal elements lie.

In other words, the at least two holding segments preferably have a lower height than the first and/or the second longitudinal element.

This configuration allows the first and/or the second longitudinal element to project at least partly beyond the holding segments which are engaged with the recesses in order to protect the edge portion from external influences and increase the stability of the structure due to an increased stiffness of the positive connection.

The first height can correspond to a height (or length) by which the recesses project out of the elongated hole. In other words, the height of the holding segments can correspond to a height by which the recesses project out of the elongated hole. Thus, a positive engagement of the holding segments with the recesses can be achieved and the stability of the structure can be increased due to an increased stiffness of the positive connection.

The clip can further comprise an end portion which is configured to connect the two longitudinal elements movably, preferably in an articulated manner.

The end portion and/or the closure element can have a minimum third height, wherein the first height is lower than the third height. In other words, the at least two holding segments preferably have a lower height than the end portion and/or the closure element.

The third height can mean an extension of the elements perpendicular to the direction from the first to the second end of the longitudinal elements and perpendicular to a direction from the first end of the first longitudinal element to the first end of the second longitudinal element connected thereto.

This configuration allows the end portion and/or the closure element to project at least partly beyond the holding segments which are engaged with the recesses in order to protect the edge portion from external influences and increase the stability of the structure due to an increased stiffness of the positive connection.

The second height can be essentially equal to the third height. In other words, the height of the first and/or the second longitudinal element can be equal to the height of the end portion and/or the closure element.

The second and/or the third height can correspond at least to the length by which the edge portion projects out of the elongated hole. Thus, the edge portion can be protected from external influences by the respective elements, and at the same time the stability of the connected elements can be increased due to an increased stiffness of the positive connection.

It is advantageous that the second and the third height correspond at least to the length by which the edge portion projects out of the elongated hole. In other words, it is particularly advantageous when the longitudinal elements, the end portion and the closure element correspond to at least the length by which the edge portion projects out of the elongated hole. This leads to an improved protection of the edge portion and an increased stability of the structure due to an increased stiffness of the positive connection.

However, a certain protection and/or a certain stability is achieved already by a corresponding height (at least the length by which the edge portion projects out of the elongated hole) of at least one of the above-mentioned elements (longitudinal element, end portion and closure element). For example, a side of the edge portion which is particularly exposed to external influences can be protected only at this side by a raised element, e.g., a longitudinal element, wherein the other elements have a lower height. Thus, the material requirements can be reduced with at the same time an increased protection from external influences.

The end portion and/or the closure element and/or the two longitudinal elements can be flush (in the assembled state) with the edge portion penetrating the elongated hole, wherein preferably the end portion, the closure element and the two longitudinal elements are flush with the end portion penetrating the elongated hole.

The edge portion can have end portions formed in different manners. For example, the end portion of the edge portion can be formed planar, i.e. the end portion is at a right angle with respect to the side faces of the edge portion and is formed essentially planar. In this case it is preferable that the above-mentioned elements of the clip (end portion, closure element and longitudinal element) are flush with the planar end portion of the edge portion.

Alternatively, the edge portion can have a trapezoidal end portion. In this case, the end portion comprises first faces which are attached to the side faces of the edge portion at an angle and a second face which has essentially a right angle with respect to the side faces of the edge portion and connects the first faces. In this embodiment, the above-mentioned elements of the clip (end portion, closure element and longitudinal element) can be preferably flush at the connection point of the first faces and the side faces of the edge portion.

Alternatively, in this embodiment the above-mentioned elements of the clip (end portion, closure element and longitudinal element) can be flush at the connection point of the second face and the first faces.

In a preferred embodiment, the edge portion can have a rounded end portion. In this embodiment, the above-mentioned elements of the clip (end portion, closure element and longitudinal element) can be preferably flush at the connection point of the rounded end portion and the side faces of the edge portion.

Alternatively, in this embodiment the above-mentioned elements of the clip (end portion, closure element and longitudinal element) can be flush at a predetermined point of the rounded end portion.

The flushness of the above-mentioned elements of the clip (end portion, closure element and longitudinal element) and the edge portion offers high protection of the edge portion against external influences and at the same time high protection of the corresponding elements of the clip because they do not project beyond the edge portion and thus are protected against, e.g., braking off or undesired opening or disconnection.

At least one holding segment can be connected to the end portion and at least one holding segment can be connected to the closure element.

Alternatively or additionally, the holding segments can be connected to the longitudinal elements.

The at least two holding segments can comprise four holding segments which are preferably arranged opposite to one another in the respective end regions of the longitudinal elements.

The opposite holding segments can have the same length or different lengths and preferably contact each other or have a small space between each other in a closed state of the clip.

Because of a small space between the holding segments, particularly preferably 0.3 mm, an increased stability as well as an advantageous consideration of manufacturing tolerances can be achieved.

The closure element can have a plurality of grooves, preferably grooves arranged in parallel, on its upper side.

The grooves can be formed by bulges on the upper side of the closure element. Alternatively, depressions can be formed in the upper face.

The grooves improve the grip of the clip and thus facilitate opening and closing of the clip.

The closure element can comprise a first closure element and a second closure element which can cooperate with each other in a positive manner.

The first closure element can have a U-shaped bracket and the second closure element can have a bulge which can cooperate with the U-shaped bracket in a closable manner.

The U-shaped bracket can have a projection and a recess.

This kind of configuration of the closure elements allows a closure which is not visible in the assembled state. Furthermore, the same force is required for opening and closing, independent of manufacturing tolerances in the area of the edge portion, in particular in the area of the bulges. By sliding the closure element open, the clip can be opened easily and comfortably.

Moreover, the clip, in particular the closure element of the clip, can be configured such that the clip remains closed only when the clip is in engagement with the edge portion, in particular the recesses of the edge portion.

In other words, the clip, in particular the closure element of the clip, can be configured such that by the edge portion, in particular the recesses of the edge portion, a force causing a permanent closure of the clip is acting on the closure element. Preferably, this closure can only be opened by a user by applying a certain force.

If, for example, the first closure element has a depression on its lower side and the second closure element has a corresponding bulge on its upper side, which can cooperate with the depression in a closable manner, the edge portion, in particular the recesses of the edge portion, exert a predetermined force on the holding segment(s). This exerted force presses the depression of the first closure element onto the bulge of the second closure element and thus holds the clip in a closed state.

In other words, the first closure element can have a depression on its lower side. The second closure element can have a bulge on its upper side, which can cooperate with the depression in a closable manner.

The lower side of the first closure element can be a face facing the upper side of the second closure element.

Also this kind of configuration of the closure elements allows a closure which is not visible in the assembled state. By a suitable selection of the above-mentioned manufacturing tolerances of the bulges, the force required for opening and closing the clip is adjustable.

The clip is preferably formed as a single piece.

The end portion preferably has a T-shaped recess. The T-shaped recess can reduce the tension at the closed side (end portion) of the clip during closing and opening. Moreover, manufacturing tolerances of the edge portion (relative to the length) can be compensated for because the internally adjoining elements of the T-shaped recess can be displaced outwardly.

The movable connection of the two longitudinal elements can be prestressed so that without the application of an external force the closure element is in an open state. This can improve the handling of the clip.

The longitudinal elements and/or the end portion and/or the closure element can have a cross-section corresponding to a rectangle, preferably a trapezoid and particularly preferably ¼ of an ellipse.

Preferably, the cross-sections of the longitudinal elements and/or the end portion and/or the closure element correspond to the shape of the end portion of the edge portion described above. Thus, the clip can terminate as positively as possible with the edge portion and provide an improved protection against external influences on the edge portion and the clip.

The recesses at the opposite end regions of the edge portion can have the same size. Thus, the same forces are acting on both sides. This increases the strength and security of the connected components.

The longitudinal elements can define a plane in the longitudinal direction and the clip can be open in both directions perpendicular with respect to the plane. This allows an easy and simple attachment of the clip even in positions that are difficult to reach.

The clip is preferably made of a plastic material and is manufactured by injection molding.

This is advantageous in that the clip can be manufactured in a cost-efficient manner, easily and individually, e.g. in different colors, with a matt and bright surface and in different shapes.

The clip can have a width between 7 mm and 40 mm, preferably between 7 mm and 24 mm, and particularly preferably between 8 mm and 22 mm.

In particular, the clip can preferably have a width of 8 mm, 10 mm, 12 mm or 22 mm.

The width of the clip corresponds to the extension of the clip from one longitudinal element to the other longitudinal element in the closed state of the clip.

The opening between the longitudinal elements of the clip can be between 3 mm to 30 mm.

The opening can extend between 20 mm and 100 mm in the longitudinal direction of the longitudinal elements.

With a width of 8 mm, the distance between the longitudinal elements can be preferably 4 mm, and the distance between the end portion and the closure element, i.e. the extension of the opening in the longitudinal direction of the longitudinal elements can be 40 mm.

The length of the clip can be between 28 mm to 116 mm.

With a width of 8 mm, the length of the clip can be preferably 48 mm.

The length of the clip extends in the longitudinal direction of the longitudinal elements.

The height of the clip, i.e. of the longitudinal elements and/or the end portion and/or the closure element can be preferably between 4.5 mm to 9.0 mm.

With a width of 8 mm, the height of the clip can be preferably 4.8 mm.

According to a further aspect of the present invention, there is provided a system comprising at least one first component, in particular a first plate element, and at least one second component, in particular a second plate element. The first component comprises at least one projecting edge portion, wherein the edge portion comprises a respective recess at its opposite end regions, and the second component comprises at least one elongated hole, wherein the edge portion penetrates the elongated hole in an assembled state and projects out of the elongated hole at least so far that the recesses project at least partly out of the elongated hole. The system further comprises at least one clip as described above in order to releasably connect the components to each other.

According to a further aspect of the present invention, there is provided a method for releasably connecting a first component, in particular a first plate element, to a second component, in particular a second plate element. The first component comprises at least one projecting edge portion, wherein the at least one edge portion comprises a respective recess at its opposite end regions, and the second component comprises at least one elongated hole. The method comprises: Passing the edge portion through the elongated hole, preferably from a first side of the second component to a second side of the second component, so that at least a part of the edge portion projects out of the elongated hole so far that the recesses project at least partly out of the elongated hole (on the second side of the second component); and releasably connecting the first component to the second component by using a clip as described above.

A further aspect of the present invention relates to the use of a clip as described above or the system as described above for assembling a furniture system, an organization or storage system, a point-of-sale display, a furniture system or housing for pets, a picture frame or a transport packaging.

Furniture systems or a housing for pets comprise various articles of daily use used in connection with pets inside or outside apartments and houses, for example sleeping places, toys and scratching posts, etc.

The clips according to the present invention are in particular not damaged by effective shear forces and, therefore, have an increased lifetime as compared to the prior art. Moreover, it is possible to achieve an increased stability of the pieces of furniture in the assembled state, which is caused by an increased stiffness of the positive connection. By the clips of the present invention, the edge portions are advantageously protected against the application of external forces such as impacts or the like. The handling of the clips of the present invention is moreover comfortable, and relatively little force is required for positioning the clips on the edge portions and for opening and closing them.

The clip can be used without using any tools, i.e. the clip can be closed and reopened in particular by hand.

In other words, i.a. an improved protection against external influences and an increased strength of the connected components can be achieved by the present invention. Moreover, the present invention is characterized by a simple handling, cost-efficient manufacturing and aesthetic quality. The person skilled in the art can take further advantageous effects of the present invention i.a. from the following detailed description of the invention.

### BRIEF DESCRIPTION OF THE DRAWINGS

In the following, the present invention will be described in more detail on the basis of embodiments and the Figures.

FIG. 1 is a perspective view of a clip according to an embodiment of the invention.

FIG. 2 is a top view of the clip in the open state according to FIG. 1.

FIG. 3 is a side view of the clip according to FIG. 1.

FIG. 4 is a bottom view of the clip in the open state according to FIG. 1.

FIG. 5 is a top view of the clip in the closed state according to FIG. 1.

FIG. 6 is a top view of a clip in the open state according to an embodiment of the invention.

FIG. 7 is a side view of the clip in the open state according to FIG. 6.

FIG. 8 is a bottom view of the clip in the open state according to FIG. 6.

FIG. 9 is a top view of a clip in the open state according to an embodiment of the invention.

FIG. 10 is a side view of the clip in the open state according to FIG. 9.

FIG. 11 is a bottom view of the clip in the open state according to FIG. 9.

FIG. 12 is a top view of a clip in the open state according to an embodiment of the invention.

FIG. 13 is a bottom view of the clip in the open state according to FIG. 12.

FIG. 14 is a top view of the clip in the closed state according to FIG. 12.

FIG. 15 is a front view of a clip in the closed state according to an embodiment of the invention.

FIG. 16 is a top view of the clip in the closed state according to FIG. 15.

FIG. 17 is a bottom view of the clip in the closed state according to FIG. 15.

FIG. 18 is a perspective view of a clip according to an embodiment of the invention.

FIG. 19 is a top view of the clip in the closed state according to FIG. 18.

FIG. 20 is a side view of the clip in the closed state according to FIG. 18.

FIG. 21 is a schematic view of a first component according to an embodiment of the invention.

FIG. 22 is a schematic view of a second component according to an embodiment of the invention.

FIG. 23 is a schematic view of a first and a second component according to an embodiment of the invention.

FIG. 24 is a schematic view of the connection of a first and a second component to a clip in the open state according to an embodiment of the invention.

FIG. 25 is a schematic view of the connection of a first and a second component to a clip in the closed state according to an embodiment of the invention.

FIG. 26 is a schematic view of an exemplary system according to an embodiment of the invention.

FIG. 27 is a schematic view of a further exemplary system according to an embodiment of the invention.

### DETAILED DESCRIPTION OF EMBODIMENTS

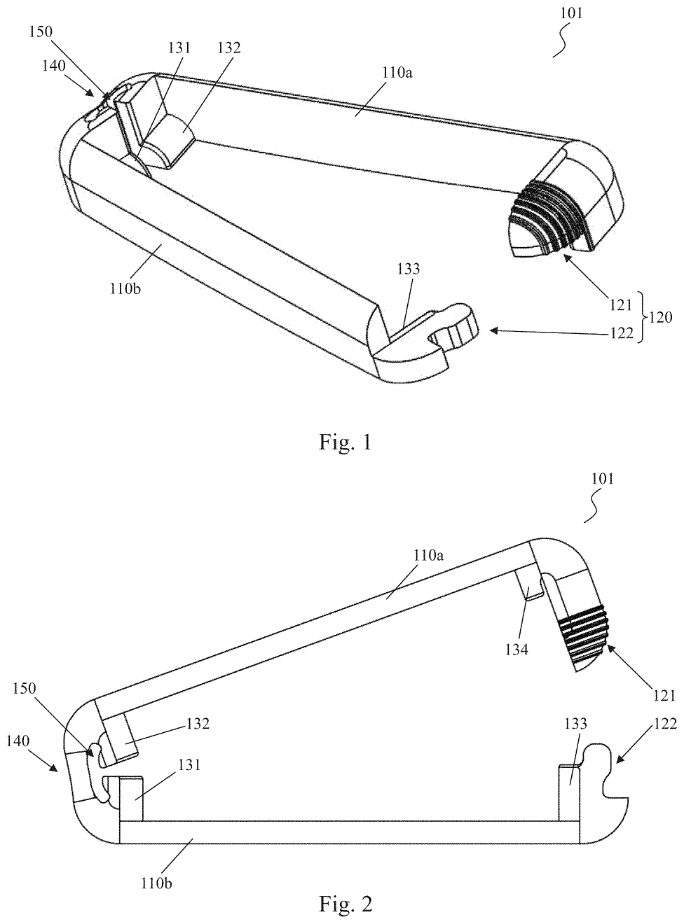

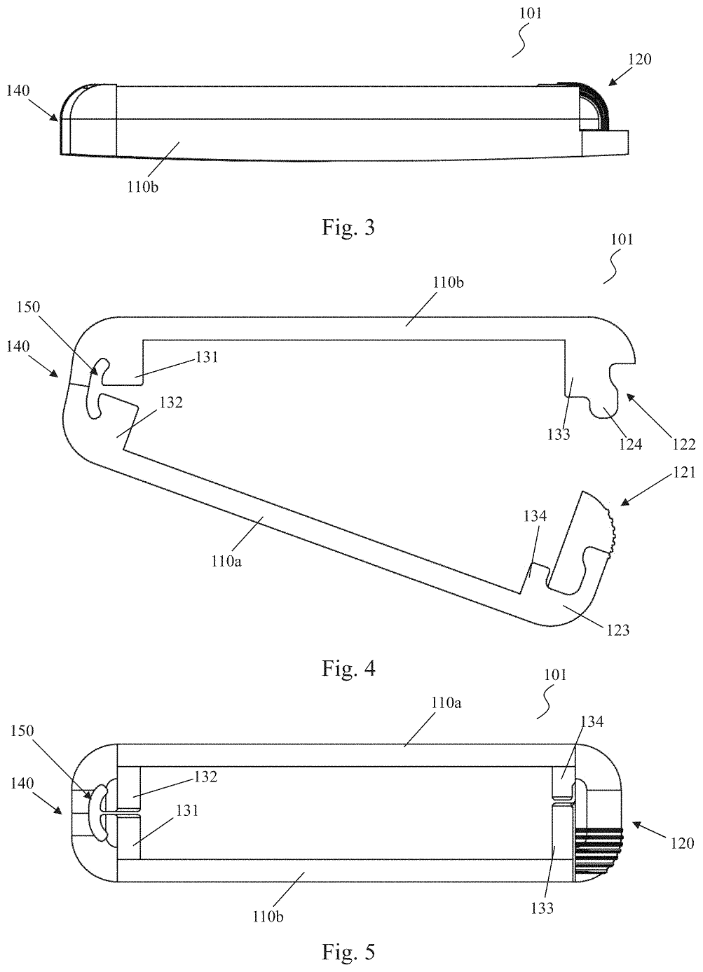

With reference to FIGS. 1 to 5, a first embodiment of a clip 101 according to the invention will be explained in more detail below. The clip 101 comprises a first longitudinal element 110a and a second longitudinal element 110b. The longitudinal elements 110a, 110b are movably (in an articulated manner) connected to each other at a respective first end by an end portion 140.

The longitudinal elements 110a, 110b have a cross-section corresponding to ¼ of an ellipse, wherein the inner sides of the longitudinal elements 110a, 110b are flat and aligned with each other.

The end portion 140 is prestressed so that without the application of an external force the closure element 101 is in an open state. In other words, the prestress of the end portion 140 provides for an angle between the first longitudinal element 110a and the second longitudinal element 110b. The angle between the first and the second longitudinal element 110a, 110b is preferably between 6° and 30° and particularly preferably between 12° and 15°.

As shown in FIG. 5, in a closed state of the clip 101 the two longitudinal elements 110a, 110b are essentially parallel to each other.

Preferably, the longitudinal elements are provided with an inwardly directed vertical bulge of about 0.3 mm, so that the longitudinal elements adjoin the edge portion better.

The end portion 140 further comprises a T-shaped recess 150 in order to reduce stress and compensate for production tolerances. The T-shaped recess 150 is arranged in the end portion 140 in a centered manner.

In other words, by a first recess which is parallel to the longitudinal elements 110a, 110b in a closed state of the clip 101, the T-shaped recess 150 divides the end portion 140 into two parts having the same size. The T-shaped recess 150 further comprises a second recess which is arranged essentially perpendicular with respect to the first recess, wherein the first recess is arranged at the second recess in an essentially centered manner.

As shown in FIGS. 1 to 5, the second recess has a curvature in the direction of the first recess (in the direction of the longitudinal elements 110a, 110b).

The clip 101 further comprises four holding segments 131 to 134. The first holding segment 131 and the second holding segment 132 are arranged at an inner side of the end portion 140 and an inner side of the respective longitudinal element 110a, 110b.

The first holding segment 131 and the second holding segment 132 project into the clip opening. The first holding segment 131 and the second holding segment 132 preferably have the same length and preferably have a lower height than the longitudinal elements 110a, 110b and the end portion.

As shown in FIG. 1, the heights of the first holding segment 131 and the second holding segment 132 increase gradually in the direction of the end portion 140 and decrease gradually in the direction of the inner space of the clip 101.

At the opposite end of the longitudinal elements 110a, 110b, the third holding segment 133 and the fourth holding segment 134 are arranged.

The heights of the third holding segment 133 and the fourth holding segment 134 increase gradually in the direction of the closure element 120 and decrease gradually in the direction of the inner space of the clip 101 (not shown in the Figures).

The third holding segment 133 projects further into the inner space of the clip 101 than the fourth holding segment 134.

The clip 101 further comprises a closure element 120 at the end of the longitudinal elements 110a, 110b opposite to the end portion 140.

The closure element 120 comprises a first closure element 121 and a second closure element 122.

The first closure element 121 has a U-shaped bracket 123. The second closure element 122 has a corresponding bulge 124.

The U-shaped bracket 123 is arranged at the first longitudinal element 110a and opened towards the inner side of the first longitudinal element 110a.

The bulge 124 is configured such that it can be received in the opening of the U-shaped bracket 123.

At the end of one of its legs, the U-shaped bracket 123 has an inwardly directed projection.

The second closure element 122 further comprises a recess into which the projection of the U-shaped bracket 123 can engage in order to hold the clip 101 in a closed stated.

The first closure element 121 can further comprise a handle element at its upper side. The handle element can have a plurality of grooves arranged in parallel (a groove structure).

The third and the fourth holding segment 133, 134 are each arranged both at the longitudinal elements 110a, 110b and the closure elements 121, 122.

The longitudinal elements 110a, 110b, the end portion 140 and the closure element 120 have essentially uniform heights and are rounded towards the top, wherein according to an embodiment a horizontal bulge of the longitudinal elements in the longitudinal direction by about 0.6 mm can be provided.

As shown in FIG. 5, in the closed state the clip 101 comprises a continuous opening formed through the longitudinal elements 110a, 110b, the end portion 140 and the closure element 120.

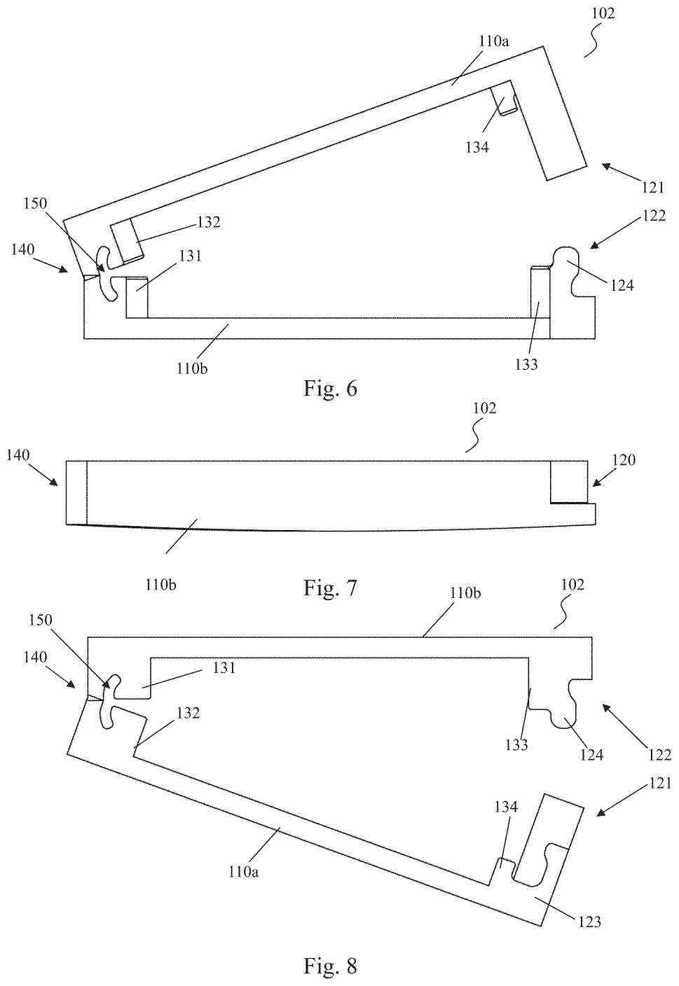

With reference to FIGS. 6 to 8, a second embodiment of a clip 102 according to the invention will be explained in more detail below. The statements made above in view of the first embodiment are essentially applicable also to the second embodiment. In the following, only the differences with respect to the first embodiment will be described in order to avoid unnecessary repetitions.

The second embodiment differs from the first embodiment in the shapes of the longitudinal elements 110a, 110b, the end portion 140 and the closure element 120. In particular, the longitudinal elements 110a, 110b, the end portion 140 and the closure element 120 according to the second embodiment have a rectangular shape.

In other words, the longitudinal elements 110a, 110b, the end portion 140 and the closure element 120 according to the second embodiment are not rounded towards the top in accordance with the first embodiment but are formed so as to have faces that are perpendicular with respect to each other.

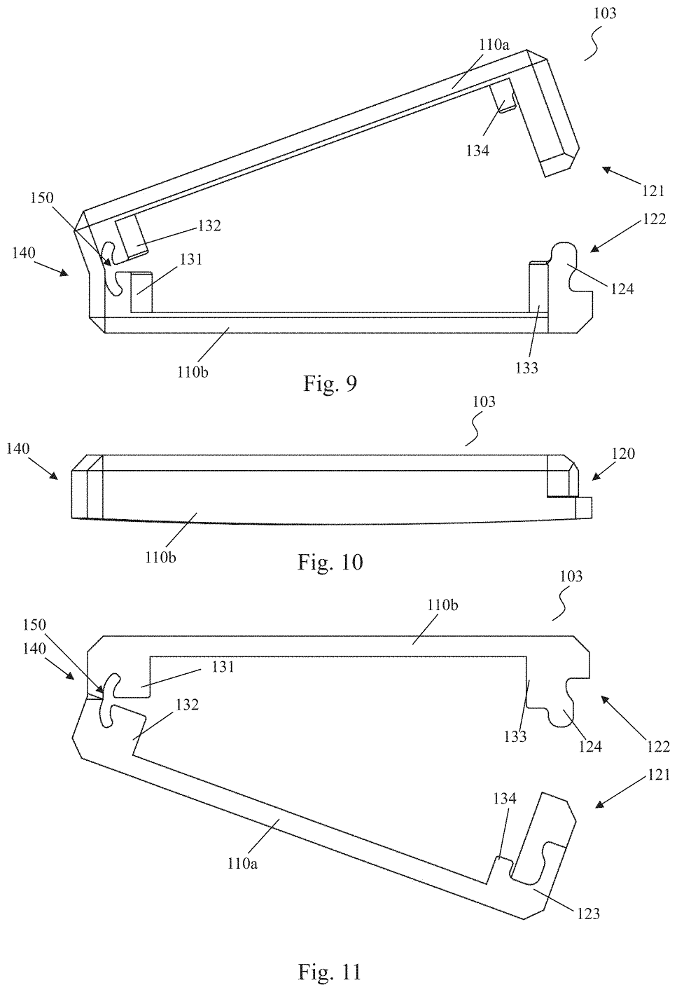

With reference to FIGS. 9 to 11, a third embodiment of a clip 103 according to the invention will be explained in more detail below. The statements made above in view of the first embodiment are essentially applicable also to the third embodiment. In the following, only the differences with respect to the first embodiment will be described in order to avoid unnecessary repetitions.

The third embodiment differs from the first embodiment in the shapes of the longitudinal elements 110a, 110b, the end portion 140 and the closure element 120. In particular, the longitudinal elements 110a, 110b, the end portion 140 and the closure element 120 according to the third embodiment have a trapezoidal shape.

In other words, the longitudinal elements 110a, 110b, the end portion 140 and the closure element 120 according to the third embodiment are not rounded towards the top in accordance with the first embodiment but are formed so as to have straight faces that are each formed at an angle (≠90°) relative to one another.

For example, the longitudinal elements 110a, 110b have two perpendicular side faces, a horizontal lower face and a horizontal upper face. The horizontal lower face connects the respective side faces at an angle of 90°. The side face lying towards the outside is shorter towards the top than the side face lying towards the inside. The horizontal upper face is directly connected to the side face lying towards the inside at an angle of 90°. An inclined face connects the shorter side face to the horizontal upper side. Thus, a corresponding longitudinal element has a trapezoidal cross-section.

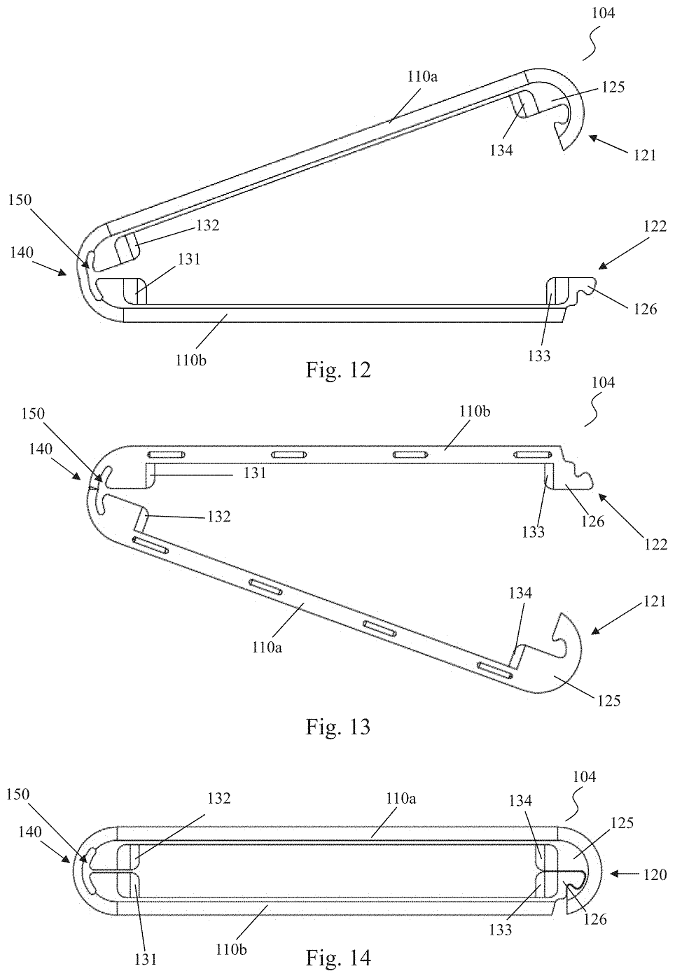

With reference to FIGS. 12 to 14, a fourth embodiment of a clip 104 according to the invention will be explained in more detail below. The statements made above in view of the first embodiment are essentially applicable also to the fourth embodiment. In the following, only the differences with respect to the first embodiment will be described in order to avoid unnecessary repetitions.

Although the fourth embodiment is shown in accordance with the shape of the first embodiment, i.e. the longitudinal elements 110a, 110b, the end portion 140 and the closure element 120 are rounded towards the top, the configurations described on the basis of the second and third embodiments (rectangular and trapezoidal) can also be applied to the fourth embodiment.

The fourth embodiment differs from the first embodiment essentially in the shape or orientation of the closure element 120. The fourth embodiment also comprises a first closure element 121 and a second closure element 122. In accordance with the first embodiment, the first closure element 121 comprises a U-shaped bracket 125 and the second closure element 122 comprises a corresponding bulge 126.

In accordance with the first embodiment, the U-shaped bracket 125 of the fourth embodiment is arranged at the first longitudinal element 110a.

In contrast to the first embodiment, the U-shaped bracket 125 of the fourth embodiment is open towards the inner side of the clip 104. In other words, the opening of the U-shaped bracket 125 of the fourth embodiment is formed so as to be parallel to the longitudinal direction of the first longitudinal element 110a. In contrast to the first embodiment in which the opening of the U-shaped bracket 123 is formed so as to be perpendicular to the longitudinal direction of the first longitudinal element 110a.

Accordingly, the bulge 126 is formed such that it can be received in the opening of the U-shaped bracket 125.

At the end of one of its legs, the U-shaped bracket 125 has an inwardly directed projection.

The second closure element 122 further comprises a recess in which the projection of the U-shaped bracket 125 can engage so as to hold the clip 104 in a closed state.

In sum, the fourth embodiment differs from the first embodiment in the orientation of the first and the second closure element 121, 122. Moreover, the closure of the fourth embodiment is visible in the assembled state.

In contrast to the first embodiment, the fourth embodiment comprises an additional element allowing the projection to be drawn or pushed over the bulge. This additional element can be, e.g., a recess for finger nails. Thus, in contrast to the first embodiment, opening comprises the further step of drawing or pushing the projection over the bulge.

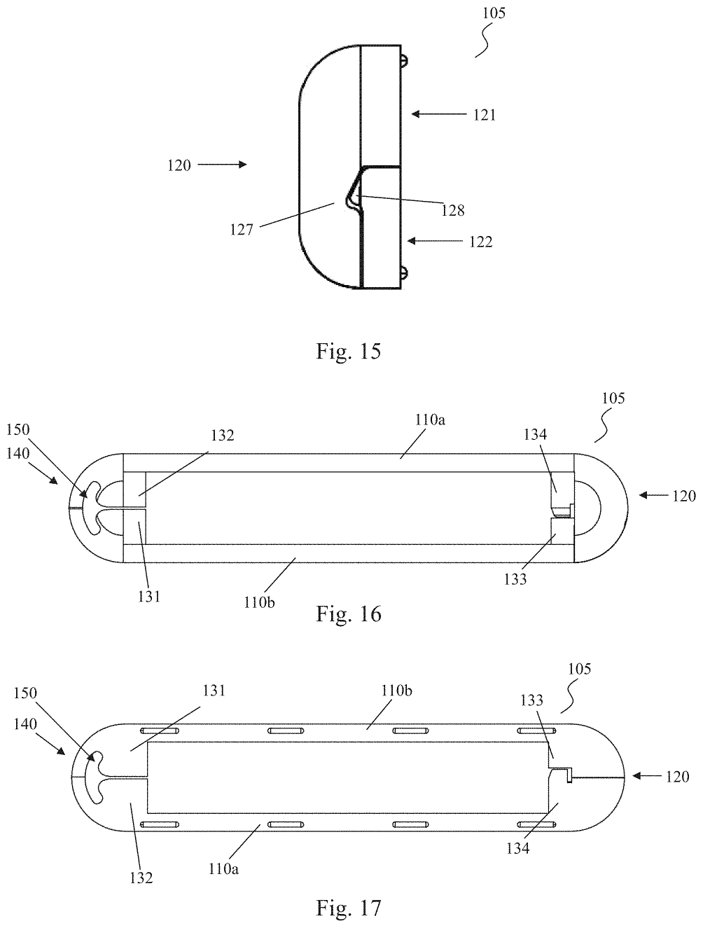

With reference to FIGS. 15 to 17, a fifth embodiment of a clip 105 according to the invention will be explained in more detail below. The statements made above in view of the first embodiment are essentially applicable also to the fifth embodiment. In the following, only the differences with respect to the first embodiment will be described in order to avoid unnecessary repetitions.

Although the fifth embodiment is shown in accordance with the shape of the first embodiment, i.e. the longitudinal elements 110a, 110b, the end portion 140 and the closure element 120 are rounded towards the top, the configurations described on the basis of the second and third embodiments (rectangular and trapezoidal) can also be applied to the fifth embodiment.

The fifth embodiment differs from the first embodiment essentially in the configuration of the closure element 120.

The closure element comprises a first closure element 121 and a second closure element 122. The first closure element 121 has a recess 127 on a lower side. The second closure element 122 has a corresponding bulge 128 on an upper side.

The recess 127 and the bulge 128 are formed at the front face of the clip 105 or the front face of the closure element 120 and configured to engage with each other so as to hold the clip 105 in a closed state.

In the fifth embodiment, the bulge 128 has a first inclination in the direction of the second longitudinal element 110b and a second inclination in the direction of the first longitudinal element 110a, wherein the first inclination is greater (steeper) than the second inclination. The recess 127 is formed accordingly.

This configuration facilitates the closing of the clip 105 due to a low resistance by the bulge 128 when the first closure element 121 is moved over the second closure element 122 for closing. At the same time, the closing force is increased due to the steeper inclination on the other side of the bulge 128 because a greater force is required for moving the first closure element 121 over the second closure element 122 for opening the clip 105.

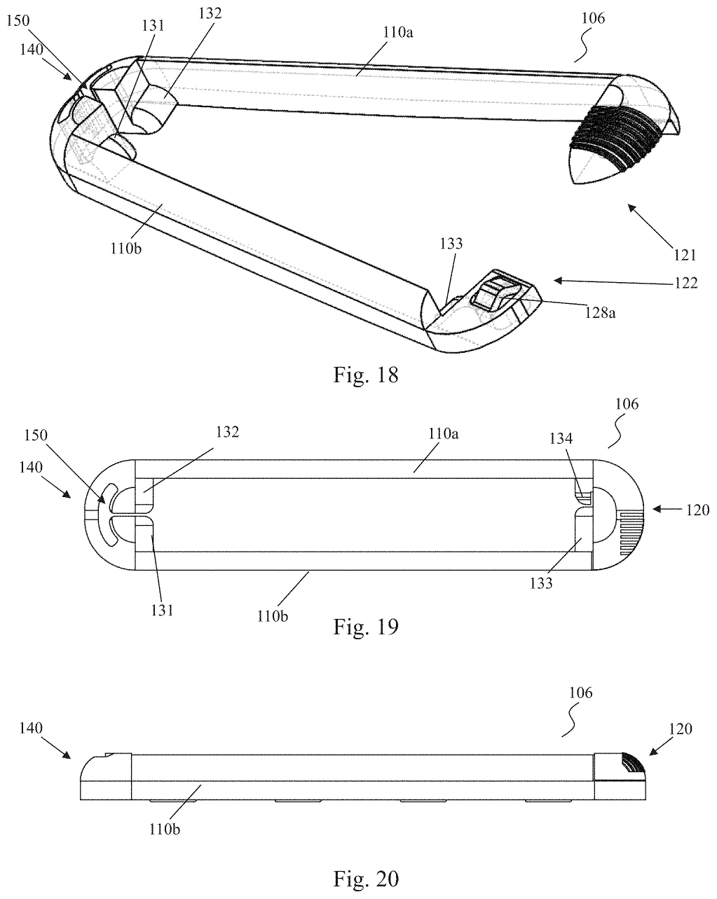

With reference to FIGS. 18 to 20, a sixth embodiment of a clip 106 according to the invention will be explained in more detail below. The statements made above in view of the first embodiment are essentially applicable also to the sixth embodiment. In the following, only the differences with respect to the first embodiment will be described in order to avoid unnecessary repetitions.

Although the sixth embodiment is shown in accordance with the shape of the first embodiment, i.e. the longitudinal elements 110a, 110b, the end portion 140 and the closure element 120 are rounded towards the top, the configurations described on the basis of the second and third embodiments (rectangular and trapezoidal) can also be applied to the sixth embodiment.

The sixth embodiment differs from the first embodiment essentially in the configuration of the closure element 120.

Similar to the fifth embodiment, the closure element 120 of the sixth embodiment comprises a recess (not shown) on the lower side of the first closure element 121 and a bulge 128a on the upper side of the second closure element 122.

The recess on the lower side of the first closure element 121 is formed such that this bulge 128a can also receive the upper side of the second closure element 122 in order to keep the clip 106 in a closed state.

The recess and the bulge 128a are each spaced from the edges of the first and the second closure element 121, 122.

In the sixth embodiment, the bulge 128a has a first inclination in the direction of the second longitudinal element 110b and a second inclination in the direction of the first longitudinal element 110a, wherein the first inclination is equal to the second inclination. The recess on the lower side of the first closure element 121 is formed accordingly.

This configuration provides for a uniform resistance during closing and opening.

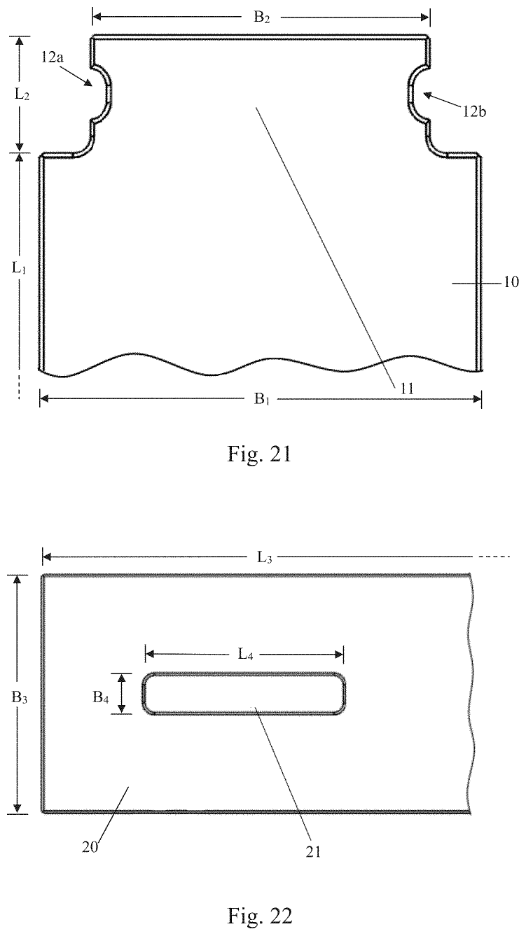

FIG. 21 shows a first component 10 comprising an edge portion 11. The edge portion 11 has a respective recess 12a, 12b at opposite end regions.

The first component 10 is preferably a plate element which extends in a planar manner and has a thickness D. In other words, the first component 10 extends in a planar manner in two spatial directions by a first length L1 and a first width B1. The component also has a thickness D in a third spatial direction, wherein the length L1 and the width B1 are >> than the thickness D. The above-mentioned spatial directions are each perpendicular with respect to each other.

The edge portion 11 extends from an end portion of the first component 10 and has a second length L2 and a second width B2, wherein preferably L1>L2 and B1>B2. The thickness of the edge portion 11 is preferably equal to the thickness D of the first component 10.

The above-mentioned lengths L1, L2 are not necessarily provided in accordance with this ratio. Rather, the second length L2 can be ≥L1. Moreover, the thickness of the edge portion 11 can differ from the thickness D of the first component 10.

The recesses 12a, 12b are provided at the end regions of the edge portions 11 in the width direction and are preferably rounded, i.e. the recesses 12a, 12b are preferably provided so as to have a round shape.

As shown in FIG. 21, the recesses 12a, 12b can be spaced from the edge portion 11 by a predetermined distance from the top and bottom (in the longitudinal direction L2). Alternatively, the recesses 12a, 12b can be provided at the lower end (in the longitudinal direction L2), i.e. the recesses 12a, 12b can extend directly from the end region of the first component 10.

Both the rounded shape of the recesses 12a, 12b and the rounded shape of the holding segments 131 to 134 described above guarantee that the holding segments 131 to 134 can be easily inserted into the recesses 12a, 12b.

Furthermore, the recesses 12a, 12b extend so far in the longitudinal direction of the edge portion 11 that the recesses 12a, 12b penetrate at least partly an elongated hole (described later in detail) of a second component.

FIG. 22 shows a second component 20 comprising an elongated hole 21. The component 20 has a length L3 and a width B3. The elongated hole 21 has a length L4 and a width B4, wherein L3>L4 and B3>B4.

The length L4 of the elongated hole 21 is greater than the width B2 of the edge portion 11 and the width B4 of the elongated hole 21 is greater than the thickness of the edge portion 11 (see description of the edge portion according to FIG. 21), so that the edge portion 11 can be passed through the elongated hole 21.

Moreover, the length L4 of the elongated hole 21 is smaller than the width B1 of the first component 10, so that only the edge portion 11 can penetrate the elongated hole 21.

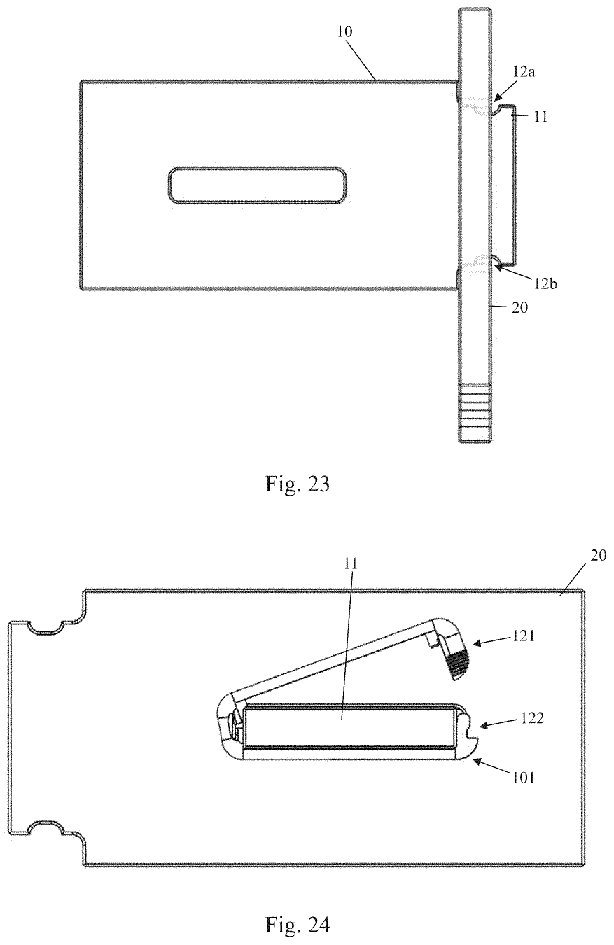

FIG. 23 shows the first component 10 and the second component 20 in a state in which the edge portion 11 penetrates the elongated hole 21. As shown in FIG. 23, the edge portion 11 projects so far out of the elongated hole 21 that the recesses 12a, 12b project at least partly out of the elongated hole 21.

As shown in FIG. 23, the first component 10 can have an additional elongated hole in addition to the edge portion 11 and the second component 20 can have an additional edge portion in addition to the elongated hole 21. Moreover, the first component 10 and/or the second component 20 can have a plurality of edge portions and/or elongated holes.

FIG. 24 shows a different perspective of a state according to FIG. 23, i.e. a state in which the edge portion 11 has been inserted through the elongated hole 21. In addition, FIG. 24 shows a clip 101 attached to the edge portion in an open state.

In this state, the holding segments 131, 133 and partly the holding segment 132 are already engaged with the recesses 12a, 12b.

In other words, according to FIG. 24 the clip 101 is placed at the edge portion 11 of the first component 10 and the holding segments 131, 132 and 133 are placed in the recesses 12a, 12b.

For closing the clip 101, the clip 101 is then closed in that the first closure element 121 is moved over the second closure element 122 and thus the holding segment 134 is also engaged with the corresponding recess.

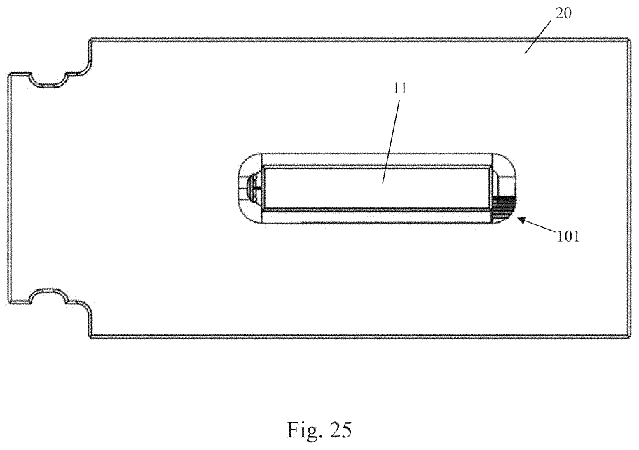

A force is exerted on the holding segments 131 to 134 by the recesses 12a, 12b, and the clip 10 is held in position. The closed state of the clip 101 is shown in FIG. 25.

The clip 101 can be reopened by applying an external force in that the first closure element 121 is pressed away from the second closure element 122.

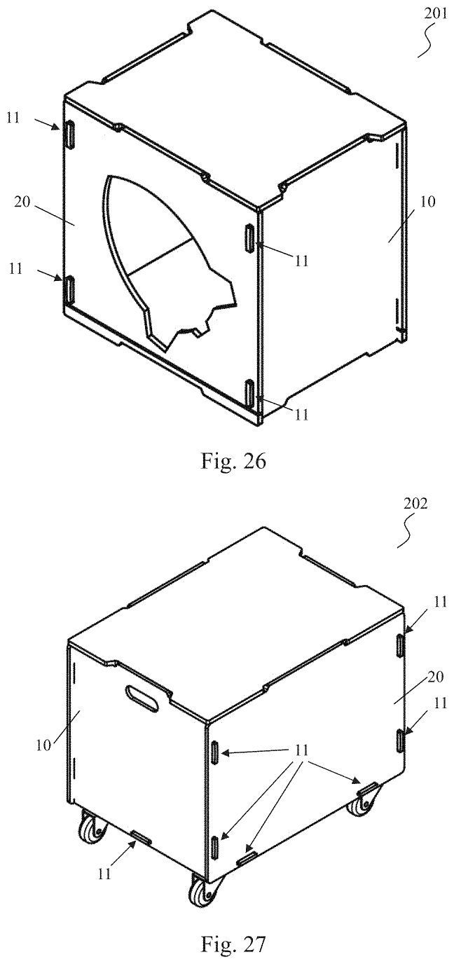

FIGS. 26 and 27 show application systems of the aspects of the invention described above. FIG. 26 shows an exemplary modular rack system 201 comprising a plurality of plate elements which have one or more edge portions 11 or elongated holes 21, as described above. For fixing the various plate elements, the clips described above (not shown) are used.

FIG. 27 shows an exemplary roll box 202 comprising a plurality of plate elements which have one or more edge portions 11 or elongated holes 21, as described above. For fixing the various plate elements, the clips described above (not shown) are used. Additional rollers are attached to the lower side of the roll box.

As shown in FIGS. 26 and 27, it is not necessary that all plate elements of the corresponding system have elongated holes or edge portions. Certain plate elements, for example the cover, can also be provided so as to have no such elements.

In other words, according to the invention it is sufficient that at least one plate element having at least one edge portion and at least one plate element having at least one elongated hole, as described above, are provided in a corresponding application system.

The application systems of FIGS. 26 and 27 are only exemplary and can be provided in various embodiments by using the invention. Further exemplary application systems relate to furniture systems, organization or storage systems, point-of-scale displays, furniture systems or housings for pets, picture frames or transport packaging.

Furniture systems or housings for pets comprise various articles of daily use used in connection with pets inside or outside apartments and houses, for example sleeping places, toys and scratching posts, etc.

The clip 101 is shown only exemplarily in FIGS. 24 to 25. It should be clear that all clips 101 to 106 described above can be used in the same manner for fixing the first plate element 10 and the second plate element 20.

While the present invention has been described and shown herein with reference to its preferred embodiments, it is obvious to the person skilled in the art that various modifications and changes can be made without leaving the scope of protection of the invention. In this manner it is intended that the present invention covers the modifications and changes of this invention, as far as they are covered by the scope of protection of the attached claims and their equivalents. Furthermore, features described in connection with a specific embodiment should not be understood exclusively in connection with other features of this embodiment. Rather, it is clear that a combination of features of different embodiments is also possible. Furthermore, a feature described in connection with another feature can also be present in a possible embodiment of the present invention without the other feature.

What is claimed is:

1. A clip for releasably connecting a first component, in particular a first plate element, to a second component, in particular a second plate element, wherein the first component comprises at least one projecting edge portion, wherein the edge portion comprises a respective recess at its opposite end regions, and the second component comprises at least one elongated hole, wherein the edge portion penetrates the elongated hole in an assembled state and projects out of the elongated hole at least so far that the recesses project at least partly out of the elongated hole,
wherein the clip comprises:
two longitudinal elements each having a first and a second end, wherein the two longitudinal elements are movably connected to each other at the respective first end;
a closure element provided at the second end of at least one longitudinal element, wherein the closure element is configured to releasably connect the second ends of the longitudinal elements; and
at least two holding segments which are provided in opposite end regions of the longitudinal elements and which are configured to be engaged with the respective recesses of the edge portion of the first component and releasably connect the components to each other.

2. The clip according to claim 1, wherein the at least two holding segments have a maximum first height and the first and/or the second longitudinal element has a minimum second height, wherein the first height is lower than the second height.

3. The clip according to claim 2, wherein the first height corresponds to a height by which the recesses project out of the elongated hole.

4. The clip according to claim 1, further comprising an end portion which is configured to connect the two longitudinal elements in a movable manner and/or wherein the end portion and/or the closure element has a minimum third height, wherein the first height is lower than the third height.

5. The clip according to claim 5, wherein the second height is essentially equal to the third height and/or wherein the second and/or the third height correspond(s) at least to the length by which the edge portion projects out of the elongated hole.

6. The clip according to claim 1, wherein the end portion and/or the closure element and/or the two longitudinal elements is/are flush with the edge portion penetrating the elongated hole.

7. The clip according to claim 5, wherein the end portion, the closure element and the two longitudinal elements are flush with the edge portion penetrating the elongated hole.

8. The clip according to claim 1, wherein at least one holding segment is connected to the end portion and at least one holding segment is connected to the closure element and/or wherein the at least two holding segments comprise four holding segments.

9. The clip according to claim 8, wherein the four holding segments are arranged opposite to one another in the respective end regions of the longitudinal elements.

10. The clip according to claim 1, wherein the closure element comprises a first closure element and a second closure element which can cooperate in a positive manner.

11. The clip according to claim 10, wherein the first closure element has a recess on its lower side and the second closure element has a bulge on its upper side, which can cooperate with the recess in a closable manner, or wherein the first closure element comprises a U-shaped bracket and the second closure element comprises a bulge, which can cooperate with the U-shaped bracket in a closable manner.

12. The clip according to claim 1, wherein the movable connection of the two longitudinal elements is prestressed so that without the application of an external force the closure element is in an open state and/or wherein the recesses at the opposite end regions of the edge portion can have the same size and/or wherein the longitudinal elements lie in one plane and the clip is open in both directions perpendicular with respect to the plane.

13. A system comprising at least one first component, in particular a first plate element, and at least one second component, in particular a second plate element, wherein the first component comprises at least one projecting edge portion, wherein the edge portion comprises a respective recess at its opposite end regions, and the second component comprises at least one elongated hole, wherein the edge portion penetrates the elongated hole in an assembled state and projects out of the elongated hole at least so far that the recesses project at least partly out of the elongated hole,
wherein the system further comprises at least one clip according to any one of the preceding claims in order to releasably connect the components to each other.

14. A method for releasably connecting a first component, in particular a first plate element, to a second component, in particular a second plate element, wherein the first component comprises at least one projecting edge portion, wherein the at least one edge portion comprises a respective recess at its opposite end regions, and the second component comprises at least one elongated hole,
wherein the method comprises:
passing the edge portion through the elongated hole, so that at least a part of the edge portion projects out of the elongated hole so far that the recesses project at least partly out of the elongated hole; and
releasably connecting the first component to the second component by using a clip according to claim 1.

15. Use of a clip according to claim 1 for assembling a piece of furniture, an organization or storage system, a point-of-scale display, a furniture system or housing for pets, a picture frame or a transport packaging.
